(19) United States
(12) Patent Application Publication
(10) Pub. No.: US 2011/0104600 A1
(43) Pub. Date: May 5, 2011

(54) ELECTROPHOTOGRAPHIC PHOTOCONDUCTOR AND IMAGE FORMING APPARATUS USING THE SAME

(76) Inventors: Takahiro Kurauchi, Osaka (JP); Satoshi Katayama, Osaka (JP); Koichi Toriyama, Osaka (JP)

(21) Appl. No.: 12/914,151

(22) Filed: Oct. 28, 2010

(30) Foreign Application Priority Data
Oct. 29, 2009 (JP) 2009-248872

(51) Int. Cl. G03G 15/00

(52) U.S. Cl. 430/56; 399/159; 430/58.85

(57) ABSTRACT

A function separation type electrophotographic photoconductor comprising: a conductive support; an undercoat layer formed on the conductive support; a charge generation layer formed on the undercoat layer; and a charge transfer layer formed on the charge generation layer, the undercoat layer containing at least a binder resin and metal oxide microparticles subjected to surface treatment with anhydrous silicon dioxide, the charge transfer layer containing at least a binder resin and an enamine compound represented by the following general formula (1):

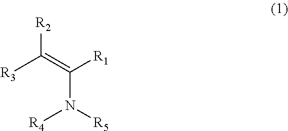

wherein one or more of R₁, R₂, R₃, R₄ and R₅ represent a C₆-C₁₀ aryl group that may have a substituent; the others each represent hydrogen atom or C₁-C₄ alkyl, C₄-C₉ heterocyclic, C₇-C₁₆ aralkyl or C₁₁-C₁₆ arylidene alkyl group that may have a substituent; or R₂ and R₃ together with carbon atoms with which they are combined may form a cyclic or condensed cyclic group that may have a substituent.

### CROSS-REFERENCE TO RELATED APPLICATION

This application is related to Japanese Patent Application No. 2009-248872 filed on 29 Oct., 2009, whose priority is claimed under 35 USC §119, and the disclosure of which is incorporated by reference in its entirety.

### BACKGROUND OF THE INVENTION

1. Field of the Invention

The present invention relates to an electrophotographic photoconductor. More particularly, the present invention relates to an electrophotographic photoconductor provided with an undercoat layer (interlayer) between a conductive support and a photosensitive layer, and an image forming apparatus.

2. Description of the Related Art

Generally, an electrophotographic process using a photoconductor having photoconductivity is one of information recording techniques utilizing a photoconduction phenomenon of the photoconductor.

According to the process, the surface of the photoconductor is first uniformly charged by corona discharge in a dark place, and then image exposure is carried out to allow an exposed portion to selectively discharge, thereby to form an electrostatic latent image on an unexposed portion. Subsequently, colored and charged microparticles (toner) are attached to the latent image by electrostatic attracting force to form a visual image, thereby forming an image being printed.

In such a series of processes, it is demanded that the photoconductor have the following fundamental characteristics:

1) The photoconductor can be uniformly charged up to an appropriate potential in a dark place;
2) The photoconductor has high charge-retaining ability and less discharge in a dark place; and
3) The photoconductor is excellent in photosensitivity and rapidly discharges by irradiation with light.

Furthermore, it is demanded that the photoconductor have the following characteristics including greater stability and durability, that is, for example, charges on the surface of the photoconductor can be removed easily, leaving reduced residual potential; the photoconductor has mechanical strength and excellent flexibility; the photoconductor is not varied in electric characteristics, in particular, in chargeability, photosensitivity and residual potential when used repeatedly; and the photoconductor has tolerance for heat, light, temperature, humidity and ozone degradation.

Since recent electrophotographic photoconductors that have been put into practical use are each provided with a photosensitive layer formed on a conductive support, carrier injection from the conductive support is likely to occur to cause surface charges on the photoconductor to be eliminated or decreased even microscopically, leading to generation of an image defect.

To prevent such an image defect, to cover defects on the surface of the conductive support, to improve chargeability, to enhance adhesion of the photosensitive layer and to improve coatability, an undercoat layer (interlayer) is disposed between the conductive support and the photosensitive layer.

Conventionally, various resin materials and resin materials containing inorganic compound particles such as titanium oxide powders have been considered for the undercoat layer.

Examples of the resin materials to be used when the undercoat layer is formed as a resin monolayer include polyethylene resins, polypropylene resins, polystyrene resins, acrylic resins, vinyl chloride resins, vinyl acetate resins, polyurethane resins, epoxy resins, polyester resins, melamine resins, silicon resins, polyvinyl butyral resins and polyamide resins.

The examples further include copolymer resins including two or more of above-mentioned resins. Furthermore, casein, gelatin, polyvinyl alcohol, ethylcellulose, and the like are known. Out of those mentioned, it is disclosed that polyamide resins are particularly preferable (Japanese Unexamined Patent Application Publication No. SHO 48 (1973)-47344).

However, with an electrophotographic photoconductor provided with a monolayer of a resin such as a polyamide as the undercoat layer, the residual potential is greatly accumulated, the sensitivity decreases, and image fogging is generated. Such a tendency is significant particularly under a low-humidity environment.

In order to prevent generation of image defects attributed to the conductive support and improve the residual potential regardless of the environment, therefore, Japanese Unexamined Patent Application Publication No. SHO 56 (1981)-52757 proposes to contain surface untreated titanium oxide powders in the undercoat layer, Japanese Unexamined Patent Application Publication No. SHO 59 (1984)-93453 proposes to contain titanium oxide microparticles coated with alumina or the like in the undercoat layer to improve the dispersibility of titanium oxide powders, Japanese Unexamined Patent Application Publication No. HEI 4 (1992)-172362 proposes to contain metal oxide particles surface treated with a titanate coupling agent in the undercoat layer, and Japanese Unexamined Patent Application Publication No. HEI 4 (1992)-229872 proposes to contain metal oxide particles surface treated with a silane compound in the undercoat layer.

When the undercoat layer is provided, however, charge injection from the photosensitive layer is inhibited to pose other problems such as deterioration in sensitivity and reduction in response speed.

In addition, miniaturization and speedup of electrophotographic devices such as digital copying machines and printers have progressed recently, and therefore it is demanded that photoconductors have higher sensitivity and higher responsiveness as their characteristics corresponding to the speedup.

As an approach to meet the above-described demand, therefore, development of charge transfer materials have been actively promoted. That is, a charge transfer material having higher charge mobility is desired, because the photosensitivity and the responsiveness are strongly dependent on the charge transfer ability of the charge transfer material.

Conventionally, as the charge transfer materials, various compounds are known such as, for example, pyrazoline compounds (Japanese Unexamined Patent Application Publication No. SHO 48 (1973)-47344), hydrazone compounds (Japanese Unexamined Patent Application Publication No. SHO 54 (1979)-150128, Japanese Unexamined Patent Application Publication No. SHO 55 (1980)-42380 and Japanese Unexamined Patent Application Publication No. SHO 55 (1980)-52063), triphenylamine compounds (Japanese Examined Patent Application Publication NO. SHO 58 (1983)-32372 and Japanese Unexamined Patent Application Publication No. HEI 2 (1990)-190862), and stilbene compounds (Japanese Unexamined Patent Application Publication No. SHO 54 (1979)-151955 and Japanese Unexamined Patent Application Publication No. SHO 58 (1983)-198043).

Recently, a pyrene derivative, a naphthalene derivative and a terphenyl derivative each having a condensed polycyclic hydrocarbon backbone as its core (Japanese Unexamined Patent Application Publication No. HEI 7 (1995)-48324), and an enamine compound having higher charge mobility (Japanese Patent No. 4101668) have been developed.

While development of surface treatment processes for metal oxide particles to be contained in the undercoat layers and development of charge transfer materials have been promoted as described above, no sufficient effect has been obtained yet, and development of an electrophotographic photoconductor that achieves good balance among environmental stability, high sensitivity and high responsiveness is desired.

It is an object of the present invention to inhibit deterioration in the sensitivity of a photoconductor due to temperature and humidity and to provide an electrophotographic photoconductor that is less prone to sensitivity variation due to repeated use, showing higher sensitivity and higher responsiveness, and free from image defects and fogging; and an image forming apparatus using the electrophotographic photoconductor.

### SUMMARY OF THE INVENTION

The inventors of the present invention have made intensive studies and efforts and, as a result, found that the above-described object can be achieved by an electrophotographic photoconductor in which a binder resin for forming an undercoat layer contains metal oxide particles subjected to surface treatment with anhydrous silicon dioxide, and a specific enamine compound is used as a charge transfer material contained in a charge transfer layer, to complete the present invention.

The achievement is considered because of the following reason, though the detailed mechanism thereof has not been revealed. That is, while charges generated in a charge generation layer upon exposure are injected into an undercoat layer and a conductive support (for example, aluminum) in this order, the charge mobility in the undercoat layer and barrier for the charge injection at an interface constitute a factor determining high responsiveness.

However, high barrier for hole injection at an interface between the charge generation layer and the charge transfer layer, or low charge mobility in the charge transfer layer will make the effect of the undercoat layer go wrong, and the interface between the charge generation layer and the charge transfer layer, or the charge transfer layer will be rate-limiting.

Accordingly, the undercoat layer and the charge transfer layer must be an excellent match with the charge generation layer (for example, in surface free energy and ionization potential) in order to achieve the above-described object.

That is, in the present invention, the combination of the two layers led to finding not only of performance enhancement in each layer but also of significant performance enhancement as a multilayer electrophotographic photoconductor.

Thus, in accordance with an aspect of the present invention, there is provided a function separation type electrophotographic photoconductor comprising: a conductive support; an undercoat layer formed on the conductive support; a charge generation layer formed on the undercoat layer; and a charge transfer layer formed on the charge generation layer, the undercoat layer containing at least a binder resin and metal oxide microparticles subjected to surface treatment with anhydrous silicon dioxide, the charge transfer layer containing at least a binder resin and an enamine compound represented by the following general formula (1):

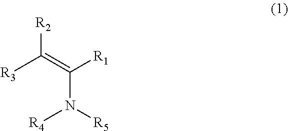

wherein one or more of R₁, R₂, R₃, R₄ and R₅ represent C₆-C₁₀ aryl group that may have a substituent; the others each represent hydrogen atom or C₁-C₄ alkyl, C₄-C₉ heterocyclic, C₇-C₁₆ aralkyl or C₁₁-C₁₆ arylidene alkyl group that may have a substituent; or R₂ and R₃ together with carbon atoms with which they are combined may form a cyclic or condensed cyclic group that may have a substituent.

### BRIEF DESCRIPTION OF THE DRAWINGS

FIG. 1 is a drawing illustrating a multilayer photoconductor of an embodiment of the present invention including an undercoat layer (interlayer), a charge generation layer and a charge transfer layer; and

FIG. 2 is a drawing illustrating an example of an image forming apparatus.

### DESCRIPTION OF THE PREFERRED EMBODIMENTS

In accordance with another aspect of the present invention, there is provided an electrophotographic photoconductor, wherein the enamine compound is used in a ratio by weight of 10/10 to 10/30 with respect to the binder resin.

In accordance with another aspect of the present invention, there is provided an electrophotographic photoconductor, wherein the metal oxide particles subjected to surface treatment with the anhydrous silicon dioxide contained in the undercoat layer have an average primary particle diameter of 20 nm to 100 nm.

In accordance with another aspect of the present invention, there is provided an electrophotographic photoconductor, wherein the metal oxide particles are used in a ratio by weight of 10/90 to 95/5 with respect to the binder resin, and the binder resin is a polyamide resin.

In accordance with another aspect of the present invention, there is provided an electrophotographic photoconductor, wherein the metal oxide particles are titanium oxide or zinc oxide particles.

In accordance with another aspect of the present invention, there is provided an electrophotographic photoconductor, wherein the undercoat layer has a film thickness of 0.05 μm to 5 μm, and when the photosensitive layer is a multilayer photosensitive layer including a charge generation layer and a charge transfer layer, the photosensitive layer includes the charge generation layer having a film thickness 0.05 μm to 5 μm.

In accordance with another aspect of the present invention, there is provided an image forming apparatus including the above-described electrophotographic photoconductor.

Aggregation of titanium oxide is prevented even in a dispersion process in a binder resin solution for a long period of time by coating titanium oxide microparticles with anhydrous silicon dioxide to obtain a stable coating solution and allow formation of a very uniform coating film for undercoat layer formation. Combination of the two layers, that is, the undercoat layer thus formed and the charge transfer layer containing at least a specific enamine compound and a binder resin lessens effects of humidity and provides an electrophotographic photoconductor that produces excellent images free from black dots and fogging, and has excellent stability in repeated use under various environments.

That is to say, in the electrophotographic photosensitive layer of the present invention, the two layers, that is, the undercoat layer containing at least a binder resin and the metal oxide particles subjected to surface treatment with anhydrous silicon dioxide, and the charge transfer layer containing at least the specific enamine compound and a binder resin are combined, thereby not only to enhance performance of each layer but also to significantly enhance performance of the photoconductor as a multilayer electrophotographic photoconductor that is unsusceptible to an environment of usage.

In addition, the present invention can provide an electrophotographic photoconductor having very stable environmental properties, preventing deterioration in image properties even in long-term and repeated use, and an image forming apparatus using the photoconductor.

A charge transfer layer in the electrophotographic photoconductor of the present invention contains an enamine compound represented by the following general formula (1):

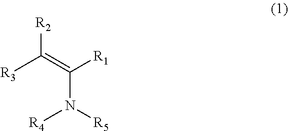

wherein one or more of R₁, R₂, R₃, R₄ and R₅ represent C₆-C₁₀ aryl group that may have a substituent; the others each represent hydrogen atom or C₁-C₄ alkyl, C₄-C₉ heterocyclic, C₇-C₁₆ aralkyl or C₁₁-C₁₆ arylidene alkyl group that may have a substituent; or R₂ and R₃ together with carbon atoms with which they are combined may form a cyclic or condensed cyclic group that may have a substituent.

Examples of the C₁-C₄ alkyl group include methyl group, ethyl group, n-propyl group, isopropyl group, n-butyl group, sec-butyl group and tert-butyl group.

Examples of the C₆-C₁₀ aryl group include phenyl group and naphthyl group.

Examples of the C₄-C₉ heterocyclic group include pyrrolyl group, imidazolyl group, pyrazolyl group, isothiazolyl group, isoxazolyl group, pyridyl group, pyrimidyl group, indolizinyl group, indolyl group, quinolizinyl group and isoquinolyl group.

Examples of the C₇-C₁₆ aralkyl group include benzyl group, phenethyl group, phenylpropyl group, phenylbutyl group, phenylpentyl group, phenylhexyl group, naphthylmethyl group, naphthylethyl group, naphthylpropyl group, naphthylbutyl group, naphthylpentyl group and naphthylhexyl group.

Examples of the C₁₁-C₁₆ arylidene alkyl group include 1-(1,2,3,4-tetrahydro)-naphthylidene methyl group, 1-(1,2,3,4-tetrahydro)-naphthylidene ethyl group, 1-(1,2,3,4-tetrahydro)-naphthylidene propyl group, 1-(1,2,3,4-tetrahydro)-naphthylidene butyl group, 1-(1,2,3,4-tetrahydro)-naphthylidene pentyl group and 1-(1,2,3,4-tetrahydro)-naphthylidene hexyl group.

Examples of the cyclic or condensed cyclic group that may have a substituent and that R₂ and R₃ together with carbon atoms with which they are combined may form include cyclopentylidene group, cyclohexylidene group, 1-(1,2,3,4-tetrahydro)-naphthylidene group, 2-(1,2,3,4-tetrahydro)-naphthylidene group.

Examples of the substituent that R₁, R₂, R₃, R₄ and R₅ may have include halogen atom, methyl group, ethyl group, methoxy group, ethoxy group, vinyl group, 2-phenylvinyl group, butadienyl group, 4-phenylbutadienyl group, 4-p-tolylbutadienyl group, 4-p-methoxybutadienyl group, 4-phenyl-4-p-methoxyphenyl butadienyl group.

More specifically, the group one or more of R₁, R₂, R₃, R₄ and R₅ can be include phenyl, p-tolyl, p-methoxyphenyl, 4-(4-phenyl butadienyl)-naphthyl and 4-(4-phenyl-4-p-methoxyphenyl butadienyl)-naphthyl groups; and examples of the others include a hydrogen atom, and 1,2,3,4-tetrahydro naphthylidene methyl, 1-(1,2,3,4-tetrahydro)-naphthylidene and 1-(1,2,3,4-tetrahydro)-naphthylidene methyl groups.

Still more specifically, examples of the enamine compound represented by the formula (1) include

an enamine compound containing hydrogen atom as R₁, phenyl groups as R₂ and R₃, p-tolyl group as R₄ and 4-(4-phenylbutadienyl)-naphthyl group as R₅, and represented by the formula (2):

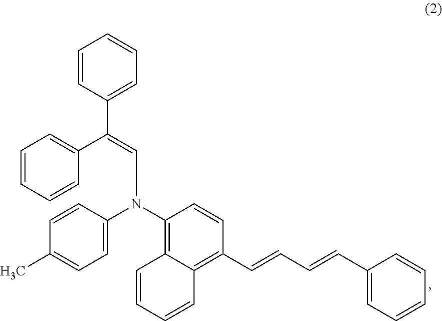

an enamine compound containing a hydrogen atom as R₁, phenyl groups as R₂ and R₃, p-tolyl group as R₄ and 4-(4-phenyl-4-p-methoxyphenyl butadienyl)-naphthyl group as R₅, and represented by the formula (3):

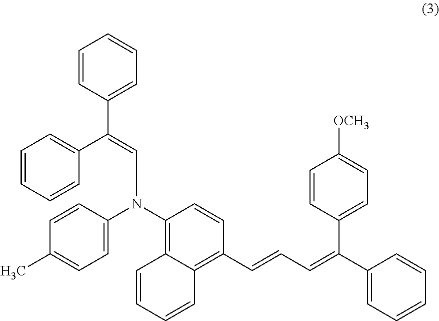

and

an enamine compound containing hydrogen atom as R₁, 1-(1,2,3,4-tetrahydro)-naphthylidene groups as R₂ and R₃, which are formed by R₂ and R₃ together with carbon atoms with which they are combined, p-methoxyphenyl group as R₄ and 1-(1,2,3,4-tetrahydro)-naphthylidene methyl group as R₅, and represented by the formula (4):

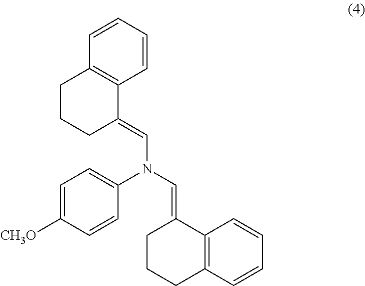

Hereinafter, the photoconductor of the present invention will be described with reference to the drawings.

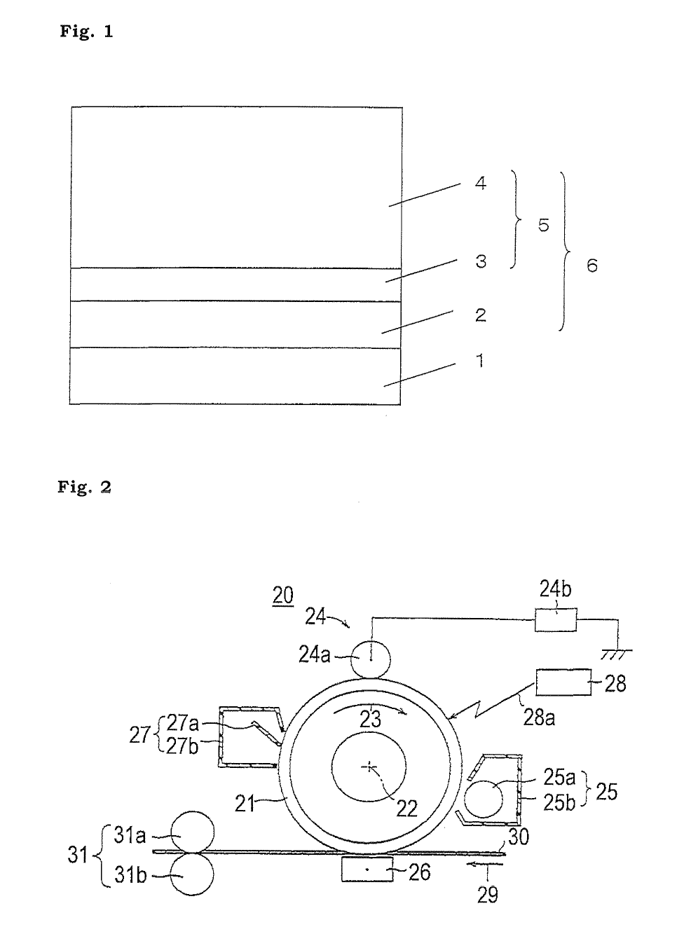

FIG. 1 is a schematic sectional view illustrating a structure of an essential part of a multilayer photoconductor of the present invention.

In the multilayer photoconductor of FIG. 1, an undercoat layer (interlayer) 2, a charge generation layer 3 containing a charge generation material and a binder resin, and a charge transfer layer 4 containing a charge transfer material and a binder resin are formed in this order on a surface of a conductive support 1.

### [Conductive Support 1]

The conductive support functions as an electrode of the photoconductor and as a support member for each layer.

The constituent material of the conductive support is not particularly limited insofar as it is used in the relevant art.

Specific examples of the constituent material include metal and alloy materials such as aluminum, aluminum alloys, copper, brass, zinc, nickel, stainless steel, chromium, molybdenum, vanadium, indium, titanium, gold and platinum; and materials obtained by laminating a metal foil, vapor depositing a metal material or an alloy material, or vapor depositing or applying a layer of a conductive compound such as a conductive polymer, tin oxide, indium oxide and carbon black on a surface of a substrate made of hard paper, glass or a polymer material such as polyethylene terephthalate, polyamide, polyester, polyoxymethylene, polystyrene, cellulose and polylactic acid.

Examples of the shape of the conductive support include sheet form, cylinder form, columnar form and endless belt (seamless belt) form.

As needed, the surface of the conductive support may be processed by an anodic oxidation coating treatment, a surface treatment using chemicals or hot water, a coloring treatment or an irregular reflection treatment such as surface roughing to the extent that the image quality is not adversely affected.

The irregular reflection treatment is particularly effective when the photoconductor of the present invention is used in an electrophotographic process using a laser as an exposure light source.

That is, since the wavelengths of laser light are uniform in an electrophotographic process using a laser as an exposure light source, laser light reflected on the surface of the photoconductor may interfere with the laser light reflected inside of the photoconductor, resulting in appearance of interference fringes on an image and occurrence of an image defect. In this respect, the image defect that may be caused by the interference of laser light with uniform wavelengths can be prevented by giving the surface of the conductive support the irregular reflection treatment.

### [Undercoat Layer (Interlayer) 2]

The undercoat layer has a function of preventing charges from being injected into a monolayer photosensitive layer or a multilayer photosensitive layer from the conductive support (being a barrier for hole injection).

In other words, deterioration in chargeability of the monolayer photosensitive layer or the multilayer photosensitive layer is inhibited, and therefore reduction in surface charges on a part other than the parts to be eliminated by exposure is inhibited by the undercoat layer, preventing generation of image defects such as fogging.

When only a resin layer is formed as the undercoat layer as is conventionally done, however, the volume resistance of the undercoat layer is so high that transfer of charges generated in the charge generation layer is inhibited and the sensitivity of the photoconductor is reduced significantly.

In addition, the conductivity of the undercoat layer will be affected by humidity variation, when an ion conductive type conductive material such as polymer electrolytes and inorganic salts is added to the resin. Specifically, the conductivity increases under a high-humidity environment, and the conductivity decreases under a low-humidity environment, significantly degrading the environmental stability of the photoconductor with respect to the sensitivity.

As the conductive material to be contained in the undercoat layer, therefore, it is preferable to use an inorganic pigment, which is unlikely to be affected by humidity, and has a volume resistance that can facilitate the charge transfer and prevent degradation of the sensitivity of the photoconductor.

Further preferable examples of the conductive material include metal oxides such as titanium oxide, zinc oxide, zinc sulfate, alumina, calcium carbonate and barium sulfate, among which titanium oxide and zinc oxide are particularly preferable, because considering the prevention of degradation of the sensitivity of the photoconductor, they are white or other colors similar to white having less absorption of visible and near-infrared light; and when image writing is performed with coherent light such as a laser beam, which has been used for light sources of image forming apparatuses in recent years, they have a larger index of refraction so as to inhibit generation of moire; and when the ratio between the resin and the conductive material in the undercoat layer is appropriately selected, they allow maintenance of the strength of the undercoat layer, prevention of image defects due to aggregation of the conductive material and easy optimization of the volume resistance.

However, when surface untreated titanium oxide or zinc oxide microparticles are used, the titanium oxide or zinc oxide microparticles will be likely to aggregate in the case of long-term use or storage of the coating solution for undercoat layer because of their micron size, even if the titanium oxide or zinc oxide microparticles are sufficiently dispersed in the coating solution. In this case, such aggregation is unavoidable.

Formation of the undercoat layer with the coating solution for undercoat layer formation that contains surface untreated titanium oxide or zinc oxide microparticles and that is stored for a long term will therefore lead to generation of a defect in the coating film and uneven coating to cause image defects.

In addition, since such a defect in the coating film and uneven coating make charge injection from the conductive support more likely, the chargeability in micro areas will be reduced to generate black dots.

Conventionally, improvement in the dispersibility in the undercoat layer has been attempted by surface treating titanium oxide or zinc oxide with alumina. In this case, however, and in the case where the undercoat layer is formed on a dram, which is a conductive support, by a dipping coating method, it was necessary to prepare a large quantity of coating solution and the dispersion process was therefore carried out over a long period of time to cause re-aggregation of the titanium oxide or the zinc oxide to generate black dots leading to reduced image quality.

That is, the alumina used for the surface treatment peeled off the titanium oxide or the zinc oxide due to the prolonged dispersion process to lessen the effect of the surface treatment of the titanium oxide or the zinc oxide and allow re-aggregation of the titanium oxide or the zinc oxide, causing an image defect and facilitating charge injection from the conductive support to reduce the chargeability in micro areas of the undercoat layer and generate black dots.

Besides, such black dots will be more significant with long-term use under a high-temperature and high-humidity environment, leading to significantly reduced image quality.

In some cases, meanwhile, silicon dioxide is used together with alumina for more sufficient surface treatment of titanium oxide or zinc oxide. However, such surface treatment with silicon dioxide together with alumina will result in inclusion of water of crystallization.

It is thought that the water of crystallization induces the undercoat layer to be susceptible to humidity in various environments, leading to reduced image quality and affecting the sensitivity of the photoconductor.

In some other cases, the surface of titanium oxide or zinc oxide is coated with a metal oxide having magnetism such as Fe₂O₃. This is not preferable, because the metal oxide chemically interacts with a phthalocyanine pigment contained in the photosensitive layer to degrade the characteristics of the photoconductor, causing reduced sensitivity and reduced chargeability, in particular.

However, the inventors of the present invention have found that by including titanium oxide or zinc oxide particles subjected to surface treatment with anhydrous silicon dioxide in the undercoat layer, it is possible to improve the dispersibility of the surface treated titanium oxide or zinc oxide in the undercoat layer, to prevent occurrence of aggregation, and to obtain a flat coating film having a uniformly maintained resistance value.

Thus, the present invention is characterized in that the undercoat layer, which is applied and formed on the surface of the conductive support, contains a binder resin and titanium oxide or zinc oxide particles subjected to surface treatment with anhydrous silicon dioxide.

Further, the undercoat layer that coats the surface of the conductive support can reduce the degree of irregularities, which is a defect of the surface of the conductive support to uniform the surface, enhance the film-forming characteristic of the monolayer photosensitive layer or the multilayer photosensitive layer, and improve the sticking characteristics (adhesion) between the conductive support and the monolayer photosensitive layer or the multilayer photosensitive layer.

As for the conventional undercoat layer, reduction of the film thickness improves the environmental properties but reduces adhesion between the conductive support and the photosensitive layer, producing an adverse effect of generation of an image defect attributed to the defect of the conductive support.

On the other hand, increase of the film thickness of the undercoat layer causes reduced sensitivity and degrades the environmental properties. Thus, the practical film thickness for achieving good balance between reduction of image defects and improvement in the stability of the electric characteristics was limited.

The crystal type of the titanium oxide may be any of a rutile type, an anatase type and amorphous, or a mixture of two or more of these types. The shape of the titanium oxide to be used is generally particulate, but may be acicular or dendritic.

In addition, the zinc oxide to be used generally has a wurtzite crystal type (hexagonal system) and a particulate shape.

The “acicular” shape, as used herein for the crystal form of an inorganic compound, means a long and narrow form including a bar-like form, a columnar form, and a spindle-like form; it does not need to be extremely long and narrow or sharp at an end.

Then, the average primary particle diameter of the titanium oxide or zinc oxide contained in the undercoat layer is preferably in a range of 20 nm to 100 nm.

It is not preferable that the average primary particle diameter is 20 nm or less, because in this case, the dispersibility may be poor to cause aggregation and increased viscosity, leading to lack of stability as a solution.

Besides, it is very difficult to apply a coating solution for undercoat layer having increased viscosity to the conductive support, leading to poor productivity.

In addition, it is not preferable that the average primary particle diameter is 100 nm or more, because in this case, the chargeability in micro areas decreases during the formation of the undercoat layer to make generation of black dots likely.

The titanium oxide or the zinc oxide having an average primary particle diameter within the above-mentioned range shows satisfactory dispersibility and therefore can be dispersed in the binder resin uniformly.

The average primary particle diameter of the titanium oxide or the zinc oxide, or the average primary particle diameter of the titanium oxide subjected to surface treatment with anhydrous silicon dioxide was determined by measuring and averaging 50 or more particles for the diameter based on observation of an SEM (S-4100, product by Hitachi High-Technologies Corporation) photograph.

The content of the titanium oxide or zinc oxide microparticles subjected to surface treatment with anhydrous silicon dioxide in the undercoat layer is in a range of 10% by weight to 99% by weight, preferably 30% by weight to 99% by weight, and more preferably 35% by weight to 95% by weight.

When the content of the titanium oxide or the zinc oxide is less than 10% by weight, the sensitivity is reduced, and charges are accumulated in the undercoat layer to increase residual potential. Such a phenomenon will be more significant particularly in repetition properties under low-temperature and low-humidity circumstances.

Furthermore, it is not preferable that the content of the titanium oxide or the zinc oxide is more than 95% by weight, because in this case, aggregates are more likely to be generated in the undercoat layer and an image defect is more likely to be generated.

The powder volume resistance of the titanium oxide or zinc oxide microparticles is preferably 10⁵Ω to 10¹⁰ Ωcm.

When the powder volume resistance is less than 10⁵ Ωcm, the resistance of the undercoat layer lowers to cause the undercoat layer to fail in functioning as a charge blocking layer.

For example, the powder volume resistance of inorganic compound particles that has undergone conductive treatment such as formation of a tin oxide conductive layer doped with antimony is as extremely low as 10⁰ Ωcm to 10¹ Ωcm. An undercoat layer using such a conductive layer is unusable, because it fails in functioning as a charge blocking layer and deteriorates the chargeability as a characteristic of the photoconductor to generate image defects such as fogging and fine black dots.

In addition, it is not preferable that the powder volume resistance of the titanium oxide or zinc oxide microparticles is more than 10¹⁰ Ωcm, that is, the powder volume resistance of the titanium oxide or zinc oxide microparticles is equal to or larger than the volume resistance of the binder resin, because in this case, the resistance as that of the undercoat layer is so high that transfer of carriers generated upon exposure is inhibited or prevented, increasing the residual potential and reducing the photosensitivity.

The amount of the anhydrous silicon dioxide for coating the surfaces of the titanium oxide or zinc oxide microparticles as used for the surface treatment is preferably 0.1% by weight to 50% by weight with respect to the amount of the titanium oxide or the zinc oxide to use.

When the amount of the anhydrous silicon dioxide is less than 0.1% by weight, the surfaces of the titanium oxide or zinc oxide cannot be coated with the anhydrous silicon dioxide sufficiently, preventing the effect of the surface treatment from being produced sufficiently.

In addition, it is not preferable that the amount of the anhydrous silicon dioxide is more than 50% by weight, because in this case, excessive anhydrous silicon dioxide remains unused for coating the titanium oxide microparticles to lessen the effect to be produced by the inclusion of the titanium oxide or zinc oxide microparticles so that the effect will be substantially the same as in the case of inclusion of silicon dioxide microparticles, and therefore the sensitivity of the photoconductor is reduced, and image fogging occurs.

In the meantime, when organic compounds such as general coupling agents are used for the surface treatment of the titanium oxide or zinc oxide microparticles, the resistance of the undercoat layer will be so high that the sensitivity variation due to the effect of humidity is reduced, but the sensitivity itself is deteriorated to cause image fogging.

It is not preferable to perform the surface treatment with an organic compound such as silane coupling agents including an alkoxysilane compound; sililating agents obtained by combining atoms of halogens, nitrogen, sulfur, and the like with silicon; titanate coupling agents; and aluminate coupling agents, because in this case, particularly significant image fogging occurs with repeated use.

### Binder Resin for Undercoat Layer

For the binder resin to be contained in the undercoat layer, the same materials as in the case of forming the undercoat layer with a resin monolayer may be used. Known examples thereof include polyethylene resins, polypropylene resins, polystyrene resins, acrylic resins, vinyl chloride resins, vinyl acetate resins, polyurethane resins, epoxy resins, polyester resins, melamine resins, silicon resins, butyral resins, polyamide resins, copolymer resins including two or more types of these repeat units, casein, gelatin, polyvinyl alcohol, and ethylcellulose. Out of these resins, polyamide resins, butyral resins, and vinyl acetate resins, which are alcohol-soluble are preferable, and polyamide resins are particularly preferable.

This is because, as characteristics of the binder resin, polyamide resins contained in the undercoat layer do not dissolve or swell in a solvent to be used when the photosensitive layer is formed on the undercoat layer, have excellent adhesion to the conductive support and flexibility, and have good affinity for the metal oxide contained in the undercoat layer to allow the metal oxide particles to well disperse and allow excellent storage stability of the dispersion liquid.

Out of the polyamide resin, alcohol-soluble nylon resins can be suitably used. Examples of the alcohol-soluble nylon resins include so-called copolymer nylons obtained by copolymerizing, for example, 6-nylon, 6,6-nylon, 6,10-nylon, 11-nylon or 12-nylon, and resins obtained by chemically modifying nylon such as N-alkoxymethyl modified nylon and N-alkoxyethyl modified nylon.

Thus, the electrophotographic photoconductor of the present invention is characterized in that the binder resin contained in the undercoat layer is an organic solvent-soluble polyamide resin.

Since the polyamide resin as the binder resin contained in the undercoat layer is easy to match with the metal oxide particles and besides excellent in adhesion with the conductive support, the undercoat layer containing the polyamide resin can maintain the flexibility of the film.

Further, the polyamide resin contained in the formed undercoat layer does not swell with or dissolve in a solvent for a coating solution for photoconductor formation to prevent occurrence of defective and uneven coating in the undercoat layer, and therefore can provide an electrophotographic photoconductor having excellent image properties.

In addition, in the present invention, the metal oxide particles are used preferably in a ratio by weight of 10/90 to 95/5 with respect to the binder resin.

For the dispersion process of the coating solution for undercoat layer formation, ultrasonic dispersers using no dispersion medium or dispersers using a dispersion medium such as a ball mill, a bead mill and a paint conditioner may be used. Out of them, the dispersers using a dispersion medium is preferable, with which the inorganic compound is put into a solution of the binder resin dissolved in an organic solvent, and the inorganic compound can be dispersed by the action of a strong force given by the disperser via the dispersion medium.

Examples of the material of the dispersion medium include glass, zircon and alumina. The examples further include zirconia and titania, which are preferably used as having higher abrasion resistance.

As for the shape and size, the dispersion medium may be in the form of a bead having a size of approximately 0.3 millimeters to several millimeters or in the form of a ball having a size of approximately several tens of millimeters.

It is not preferable to use glass as the material of the dispersion medium, because in this case, the viscosity of the dispersion liquid increases to reduce the storage stability.

This is considered based on the fact that, when the metal oxide microparticles used in the present invention are dispersed, the strong force given by the disperser is used not only as energy for dispersing the metal oxide microparticles but also as energy for abrading the dispersion medium itself so that the material of the dispersion medium generated due to the abrasion of the dispersion medium is mixed in the coating dispersion to deteriorate the coating dispersion in dispersibility and storage stability, having some effects on the applicability and the film quality of the undercoat layer in the formation of the undercoat layer of the electrophotographic photoconductor.

General organic solvents can be used as the organic solvent for the dispersion liquid for forming the undercoat layer of the electrophotographic photoconductor of the present invention. When an alcohol-soluble nylon resin, which is more preferable as the binder resin, is used, in particular, organic solvents such as lower alcohols having 1 to 4 carbon atoms are used.

More particularly, the solvent of the coating solution for undercoat layer formation is preferably a lower alcohol selected from the group consisting of methyl alcohol, ethyl alcohol, isopropyl alcohol, n-propyl alcohol, n-butyl alcohol, isobutyl alcohol and t-butyl alcohol.

The coating solution for undercoat layer formation is prepared by dispersing the polyamide resin and the titanium oxide microparticles in the lower alcohol, and the undercoat layer is formed by applying and drying the coating solution on the conductive support.

The undercoat layer can be obtained by applying the coating solution for undercoat layer formation of the present invention onto the conductive support, and then drying the coating film obtained, for example.

Examples of the method for applying the coating solution for undercoat layer formation include a Baker applicator method, a bar-coater method (for example, wire bar-coater method), a casting method, a spin coating method, a roll method, a blade method, a bead method, a curtain method in the case of sheets; and a spray method, a vertical ring method and a dipping coating method in the case of drums.

As the application method, the most suitable method may be selected in consideration of the physical properties of the coating solution and productivity, and a dipping coating method, a blade coater method and a spray method are particularly preferable.

The film thickness of the undercoat layer is preferably in a range of 0.01 μm to 10 μm, and more preferably in a range of 0.05 μm to 5 μm.

When the film thickness of the undercoat layer is less than 0.01 μm, the film does not substantially function as an undercoat layer, and then it is impossible to obtain a uniform surface by covering defects of the conductive support to fail in preventing carrier injection from the conductive support and cause deterioration in the chargeability.

In addition, it is not preferable that the film thickness of the undercoat layer is more than 10 μm, because in this case, application of the undercoat layer by a dipping coating method is difficult in the production of the photoconductor, and the sensitivity of the photoconductor is reduced.

### [Photosensitive Layer 5 of Multilayer Photoconductor]

The photosensitive layer 5 is composed of the charge generation layer 3 and the charge transfer layer 4. An optimum material for forming each layer can be independently selected by assigning a charge generation function and a charge transfer function to separate layers.

Hereinafter, a multilayer photoconductor (FIG. 1) formed by stacking the charge generation layer and the charge transfer layer in this order will be described. However, the description is basically true of a multilayer photoconductor of a reverse double layer type except that the stacking order is different.

### [Charge Generation Layer 3]

In the case of a function separation type photosensitive layer, the charge generation layer is formed on the undercoat layer. Known examples of the charge generation material contained in the charge generation layer include bis-azo compounds such as chlorodian blue, polycyclic quinone compounds such as dibromoanthanthrone, perylene compounds, quinacridon compounds, phthalocyanine compounds and azulenium salt compounds. The electrophotographic photoconductor performing image formation using a laser beam or an LED as a light source by a reverse developing process is required to have sensitivity in a long-wavelength region of 620 nm to 800 nm.

As the charge generation material to be used for this purpose, phthalocyanine pigments and trisazo pigments have been considered as having high sensitivity and excellent durability. In particular, the phthalocyanine pigments have still more excellent characteristics, and one or more kinds of the pigments may be used independently or in combination.

Examples of the usable phthalocyanine pigments include metal-free phthalocyanines and metallophthalocyanines, and mixtures and mixed crystal compounds thereof.

Examples of the metal usable for the metallophthalocyanine pigments include metals being zero in the oxidation state, halides of the metals such as chlorides and bromides, and oxides. Preferable examples of the metal include Cu, Ni, Mg, Pb, V, Pd, Co, Nb, Al, Sn, Zn, Ca, In, Ga, Fe, Ge, Ti and Cr. While various kinds of techniques have been proposed as the production method of these phthalocyanine pigments, any production method may be used. For example, may be used phthalocyanines subjected to various kinds of purification or dispersion processes with various kinds of organic solvents for conversion of the crystal type after having been prepared to be pigments.

Examples of the charge generation material include α-type, β-type, γ-type and amorphous titanylphthalocyanines, which are different in crystal type; other phthalocyanines; azo pigments; anthraquinone pigments; perylene pigments; polycyclic quinone pigments; and squarylium pigments.

Examples of the method for preparing the charge generation layer using these phthalocyanine pigments include a method in which a charge generation material, in particular, a phthalocyanine pigment is vacuum deposited; and a method in which a charge generation material is mixed with a binder resin and an organic solvent, and dispersed therein to form a film, before which the charge generation material may be preliminarily milled by use of a milling machine. Examples of the milling machine include a ball mill, a sand mill, an attritor, an oscillation mill and an ultrasonic dispersing machine.

In general, a method in which a charge generation material is dispersed in a binder resin solution, and then applied is preferable. Examples of the application method include a spray method, a bar coating method, a roll coating method, a blade method, a ring method and a dipping coating method.

The dipping coating method is a method in which a conductive support is dipped in a coating vessel filled with a coating solution and then raised at a constant speed or a sequentially varied speed thereby to form a layer on the conductive support. This method is frequently used in production of photoconductors as being relatively simple and excellent in productivity and production cost. The apparatus to be used for the dipping coating method may be provided with a coating solution dispersing machine typified by ultrasonic generators to stabilize the dispersibility of the coating solution.

Examples of the binder resin usable for the coating solution for charge generation layer formation include melamine resins, epoxy resins, silicon resins, polyurethane resins, acrylic resins, polycarbonate resins, polyarylate resins, phenoxy resins, butyral resins, and copolymer resins including two or more types of these repeat units, for example, insulating resins such as vinyl chloride-vinyl acetate copolymer resins and acrylonitrile-styrene copolymer resins. The binder resin is not limited to these resins, and all resins that are generally used may be used independently or in combination of two or more kinds thereof.

Examples of the solvent in which these resins are dissolved include halogenated hydrocarbons such as dichloromethane and dichloroethane; ketones such as acetone, methyl ethyl ketone and cyclohexanone; esters such as ethyl acetate and butyl acetate; ethers such as tetrahydrofuran and dioxane; aromatic hydrocarbons such as benzene, toluene and xylene; and aprotic polar solvents such as N,N-dimethylformamide and N,N-dimethylacetamide, and mixed solvents of these solvents.

Preferably, the phthalocyanine pigment and the binder resin are blended so that the proportion of the phthalocyanine pigment will be in a range of 10% by weight to 99% by weight. When the proportion of the phthalocyanine pigment is less than the lower limit of this range, the sensitivity is reduced. When the proportion of the phthalocyanine pigment is more than the upper limit of this range, the dispersibility as well as the durability is reduced to increase coarse particles, leading to generation of more image defects, in particular, more black dots.

To prepare the coating solution for charge generation layer formation, the phthalocyanine pigment is mixed with the binder resin and the organic solvent, and then dispersed therein. For the dispersion, appropriate conditions may be selected so as to prevent contamination of the solution with impurities generated due to abrasion or the like of the container and the dispersing machine to use.

It is essential that the phthalocyanine pigment contained in the dispersion liquid obtained as described above is dispersed to the extent that the primary particle diameter and/or the aggregated particle diameter will be 3 μm or less.

When the primary particle diameter and/or the aggregated particle diameter are larger than 3 μm, the resulting electrophotographic photoconductor will produce an extraordinary number of black dots on a white background in the case of inverse development. When the coating solution for charge generation layer formation is prepared with various dispersers, therefore, the dispersion conditions are optimized so that the phthalocyanine pigment particles are dispersed to be preferably 3 μm or less in diameter, and more preferably 0.5 μm or less in median diameter and 3 μm or less in mode diameter. Preferably, no particles larger than the above-specified diameters are contained.

Since microparticulation of the phthalocyanine pigment particles requires relatively intensive dispersion conditions and longer dispersion time due to their chemical structure, further dispersion leads to cost inefficiency and unavoidable contamination with impurities due to abrasion of the dispersion medium.

Further dispersion also leads to change in the crystal type of the phthalocyanine pigment particles caused by the organic solvent and heat during the dispersion process or shock by the dispersion to produce an adverse effect such as significant reduction in the sensitivity of the photoconductor. It is therefore not preferable that the phthalocyanine pigment particles are micrified to be 0.01 μm or less in median diameter and 0.1 μm or less in mode diameter.

When the phthalocyanine pigment particles dispersed in the coating solution include particles having a diameter of larger than 3 μm, the primary particles and/or the aggregated particle having a diameter of larger than 3 μm can be removed by performing filtration. As the material of the filter usable for the filtration, general materials are used as long as they do not swell with or dissolve in the organic solvent used for the dispersion, and Teflon (registered trademark) membrane filter having a uniform pore size is preferably used. Further, coarse particles and aggregates may be removed by centrifugal separation.

In the present invention, the charge generation layer to be formed using the coating solution for charge generation layer formation obtained as described above is applied so as to be a film preferably having a thickness in a range of 0.05 μm to 5 μm, and more preferably having a thickness in a range of 0.08 μm to 1 μm.

The film thickness of the charge generation layer of less than 0.05 μm is not preferable, because it results not only in reduction in the sensitivity but also in change in the crystal type due to the need for the phthalocyanine pigment to be dispersed until their particles become very small.

The film thickness of the charge generation layer of more than 5 μm is not preferable, either, in terms of the cost and difficulty in uniform application of the charge generation layer, though it gives certain sensibility.

When the film thickness of the charge generation layer is increased in the conventional structure of the undercoat layer and the photosensitive layer, there was produced an adverse effect such as generation of image defects including fine black dots on a white background generated due to elimination of surface charges in micro areas, though the sensitivity characteristics were improved.

On the other hand, when the film thickness of the undercoat layer decreased, the sensitivity is reduced. Thus, the practical film thickness for achieving good balance between reduction of image defects, and improvement in the electric characteristics and the production stability was limited.

However, since use of the undercoat layer containing the metal oxide particles, in particular, titanium oxide microparticles subjected to surface treatment with anhydrous silicon dioxide of the present invention improved the dispersibility of the undercoat layer, generation of aggregates can be prevented and the coating film can be flat and have a uniformly maintained resistance. As a result, it is possible to uniformly maintain microscopic characteristics of the photoconductor, in particular, fluctuation of the sensitivity and the residual potential, and therefore it is possible to inhibit generation of image defects and image fogging even when the film thickness of the charge generation layer is increased. Further, since the film thickness of the charge generation layer can be increased, higher sensitivity can be achieved.

### [Charge Transfer Layer 4]

Typical examples of the method for producing the charge transfer layer to be provided on the charge generation layer include a method in which a coating solution for charge transfer layer formation is prepared by dissolving a charge transfer material in a binder resin solution, and the coating solution is applied to form a film.

As the binder resin, one or more kinds of the resins mentioned for the charge generation layer may be used independently or in combination. For the production of the charge transfer layer, the same method as for the undercoat layer may be employed.

The charge transfer layer is obtained by including, in the binder resin, the enamine compound represented by the general formula (1), more specifically the enamine compound represented by any of the formulae (2) to (4) as a charge transfer material capable of receiving and transferring charges generated in the charge generation material.

The enamine compound represented by the general formula (1), more specifically the enamine compound represented by any of the formulae (2) to (4) of the present invention was prepared according to a method disclosed in Japanese Patent No. 4101668.

As the binder resin for the charge transfer layer, a resin having excellent compatibility with the charge transfer material is selected. Specific examples thereof include polymethylmethacrylate resins, polystyrene resins, vinylpolymer resins such as polyvinyl chloride resins and their copolymer resins, polycarbonate resins, polyester resins, polyester carbonate resins, polysulfone resins, phenoxy resins, epoxy resins, silicone resins, polyarylate resins, polyamide resins, polyether resins, polyurethane resins, polyacrylamide resins, and phenol resins.

In addition, heat curing resins obtained by partially cross-linking the above-mentioned resins may be used. These resins may be used independently or in combination of two or more kinds thereof.

Out of the above-mentioned resins, polystyrene resins, in particular, polycarbonate resins, polyarylate resins and polyphenylene oxides are preferably used for the binder resin, because they are excellent in the film-forming characteristics, the potential characteristics, and the like as well as in the electric insulation, having a volume resistance of 10¹³Ω or more.

While the ratio by weight A/B between the charge transfer material (A) and the binder resin (B) is approximately 10/12 in general, the ratio by weight is 10/12 to 10/30 in the electrophotographic photoconductor of the present invention.

As described above, the charge transfer material is the enamine compound represented by any of the formulae (2) to (4) having high charge mobility and functions also as an organic photoconductive material. Accordingly, the photoresponsivity can be maintained even when the ratio A/B is 10/12 to 10/30, that is, when the charge transfer material is added to the binder resin at a higher ratio than that of the case where a conventionally known charge transfer material is used.

Thus, the printing durability of the charge transfer layer is improved without reducing the photoresponsivity to allow improvement in the durability of the electrophotographic photoconductor.

When the ratio A/B is less than 10/30, that is, the proportion of the binder resin is higher and when the charge transfer layer is formed by a dipping coating method, the viscosity of the coating solution increases to cause reduction in the application speed, leading to significantly low productivity. Meanwhile, when the amount of the solvent in the coating solution is increased in order to restrict increase in the viscosity of the coating solution, a brushing phenomenon occurs and the resulting charge transfer layer becomes cloudy.

On the other hand, when the ratio A/B is more than 10/12, that is, the proportion of the binder resin is lower, the printing durability is lower than that in the case where the proportion of the binder resin is higher, leading to increase in the abrasion of the photosensitive layer. The ratio A/B was therefore set to 10/12 to 10/30.

As needed, the charge transfer layer 4 may contain an additive such as a plasticizer and a leveling agent in order to improve the film-forming characteristics, the flexibility, and the surface smoothness. Examples of the plasticizer include dibasic acid esters, fatty acid esters, phosphoric esters, phthalate esters, chlorinated paraffins, and epoxy type plasticizers. Examples of the leveling agent include silicone type leveling agents.

In addition, the charge transfer layer may contain microparticles of an inorganic compound or an organic compound in order to enhance the mechanical strength and improve the electric characteristics.

Further, the charge transfer layer may contain other various additives such as an antioxidant and a sensitizer as needed. Such additives can improve the potential characteristic, enhance the stability of the coating solution, reduce fatigue deterioration when the photoconductor is used repeatedly, and improve the durability.

As the antioxidant, a hindered phenol derivative or a hindered amine derivative is suitably used. It is preferable that the hindered phenol derivative is used in a range of 0.1% by weight to 50% by weight with respect to the charge transfer material. It is preferable that the hindered amine derivative is used in a range of 0.1% by weight to 50% by weight with respect to the charge transfer material.

The hindered phenol derivative and the hindered amine derivative may be used in combination. In this case, it is preferable that the total amount of the hindered phenol derivative and the hindered amine derivative to use is in a range of 0.1% by weight to 50% by weight with respect to the charge transfer material.

When the amount of the hindered phenol derivative, the amount of the hindered amine derivative or the total amount of the hindered phenol derivative and the hindered amine derivative is less than 0.1% by weight, it is impossible to obtain an effect sufficient to improve the stability of the coating solution and the durability of the photoconductor. On the other hand, the amount of the antioxidant of more than 50% by weight will have an adverse effect on the characteristics of the photoconductor.

The amount of the antioxidant was therefore set to be in a range of 0.1% by weight to 50% by weight.

As in the case of the formation of the above-described charge generation layer, for example, the charge transfer layer 4 is formed by dissolving or dispersing the charge transfer material and the binder resin, and, as needed, an additive as mentioned above in an appropriate solvent to prepare a coating solution for charge transfer layer formation, and applying the coating solution onto the charge generation layer by a spray method, a bar coating method, a roll coating method, a blade method, a ring method, a dipping coating method, or the like.

Out of these application methods, in particular, the dipping coating method is frequently used for the formation of the charge transfer layer 4, because it is excellent in various points as described above. The solvent to be used for the coating solution is selected from the group consisting of aromatic hydrocarbons such as benzene, toluene, xylene and monochlorobenzene; halogenated hydrocarbons such as dichloromethane and dichloroethane; ethers such as THF, dioxane and dimethoxymethyl ether; aprotic polar solvents such as N,N-dimethylformamide; and the like. These solvents are used independently or in combination of two or more kinds thereof. As needed, a solvent such as alcohols, acetonitrile, and methyl ethyl ketone may be further added to the solvent.

The thickness of the charge transfer layer 4 is preferably in a range of 5 μm to 50 μm, and more preferably in a range of 10 μm to 40 μm. The film thickness of the charge transfer layer 4 of less than 5 μm leads to deterioration in the charge retention ability on the surface of the photoconductor. The film thickness of the charge transfer layer 4 of more than 50μ leads to decrease in the resolution of the photoconductor. The film thickness of the charge transfer layer was therefore set to be in a range of 5 μm to 50 μm.

In order to improve the sensitivity, and inhibit increase in the residual potential and fatigue due to repeated use, one or more kinds of electron acceptor substances and dyes may be further added to the photosensitive layer.

Examples of the electron acceptor substances include acid anhydrides such as succinic anhydride, maleic anhydride, phthalic anhydride and 4-chloronaphthalic acid anhydride; cyano compounds such as tetracyanoethylene and terephthalmalondinitrile; aldehydes such as 4-nitrobenzaldehyde, anthraquinones such as anthraquinone and 1-nitroanthraquinone; polycyclic or heterocyclic nitro compounds such as 2,4,7-trinitrofluorenone and 2,4,5,7-tetranitrofluorenone; electron attractive materials such as diphenoquinone compounds; compounds obtained by polymerizing these electron attractive materials; and the like.

Examples of the dyes include xanthene type dyes, thiazine dyes, triphenylmethane dyes, quinoline type pigments and organic photoconductive compounds such as copper phthalocyanine. These organic photoconductive compounds function as an optical sensitizer.

### [Protective Layer (not Shown)]

The photoconductor of the present invention may have a protective layer (not shown) on a surface of the photosensitive layer of the multilayer photoconductor.

The protective layer has a function of improving the abrasive resistance of the photosensitive layer and preventing chemically adverse effects due to ozone and nitrogen oxides.

Further, the protective layer may be provided in order to protect the surface of the photosensitive layer, when needed.

Thermoplastic resins and light or heat curing resins can be used for the protective layer. In addition, the protective layer may contain an ultraviolet preventive, an antioxidant, an inorganic material such as metal oxides, an organic metal compound and an electron acceptor substance such as those mentioned above.

The protective layer may be formed, for example, by dissolving or dispersing a binder resin and additives such as an antioxidant and an ultraviolet absorber as needed in an appropriate organic solvent to prepare a coating solution for protective layer formation, and applying the coating solution onto the surface of the monolayer photosensitive layer or the multilayer photosensitive layer, and then drying the same to remove the organic solvent.

Other steps and conditions therefor are in accordance with those in the formation of the charge generation layer.

Though not particularly limited, the film thickness of the protective layer is preferably 0.5 μm to 10 μm, and particularly preferably 1 μm to 5 μm. The film thickness of the protective layer of less than 0.5 μm may lead to poor abrasion resistance in the surface of the photoconductor and insufficient durability. On the other hand, the film thickness of the protective layer of more than 10 μm may decrease the resolution of the photoconductor.

In addition, for the photosensitive layer and the protective layer, a plasticizer such as a dibasic acid ester, fatty acid ester, phosphate, phthalate and chlorinated paraffin may be optionally mixed to make such an improvement in mechanical properties as to impart processability and flexibility, or a leveling agent such as a silicon resin may be used.

The electrophotographic photoconductor of the present invention can be used for electrophotographic copying machines, and various printers and electrophotographic plate making systems having a lasers or a light emitting diode (LED) as their light sources.

### [Image Forming Apparatus 20]

The image forming apparatus 20 of the present invention comprises at least: the photoconductor 21 of the present invention; a charge means for charging the photoconductor; an exposure means for exposing the charged photoconductor to form an electrostatic latent image; a development means for developing the electrostatic latent image formed by the exposure to form a toner image; a transfer means for transferring the toner image formed by the development onto a recording medium; and a fixing means for fixing the transferred toner image onto the recording medium to form an image.

The image forming apparatus of the present invention will be described with reference to the drawings, but the present invention is not limited to the following descriptions.

FIG. 2 is a schematic side view illustrating a structure of an image forming apparatus of the present invention.

The image forming apparatus 20 in FIG. 2 includes the photoconductor 21 of the present invention, the charge means (charger) 24, the exposure means 28, the development means (developing unit) 25, the transfer means (transfer unit) 26, a cleaning means (cleaner) 27, the fixing means (fixing unit) 31 and a discharge means (not shown, attached to the cleaning means 27). The reference numeral 30 represents a transfer paper.

The photoconductor 21 is supported in a freely rotatable manner by the main body, not shown, of the image forming apparatus 20 and driven to rotate in a direction of an arrow 23 around a rotation axis 22 by a drive means, not shown. The drive means has, for example, a structure including an electric motor and reduction gears, and transmits its drive force to a conductive support constituting the core body of the photoconductor 21 to thereby drive the photoconductor 21 to rotate at a predetermined peripheral speed. The charger 24, the exposure means 28, the developing unit 25, the transfer unit 26 and the cleaner 27 are disposed in this order towards a downstream side from an upstream side in the direction of the rotation of the photoconductor 21 as shown by the arrow 23 along the outside peripheral surface of the photoconductor 21.

The charger 24 is a charging means for charging the outside peripheral surface of the photoconductor 21 to a predetermined potential. Specifically, the charger 24 is achieved by, for example, a charge roller 24a of a contact type, a charge brush or a charger wire such as a corotron or a scorotron. The reference numeral 24b represents a bias power.

The exposure means 28 is provided with, for example, a semiconductor laser as a light source, and applies laser light 28a output from the light source between the charger 24 and the developing unit 25 of the photoconductor 21 to expose the outside peripheral surface of the charged photoconductor 21 according to image information. The light 28a is repeatedly passed for scanning in a main scanning direction, that is, a direction to which the rotation axis 22 of the photoconductor 21 extends, to sequentially form electrostatic latent images on the surface of the photoconductor 21.

The developing unit 25 is a development means for developing the electrostatic latent image formed by exposure on the surface of the photoconductor 21 with a developer. The developing unit 25 is disposed facing the photoconductor 21 and provided with a development roller 25a that supplies a toner to the outside peripheral surface of the photoconductor 21 and a case 25b that supports the development roller 25a in such a manner as to be rotatable around a rotation axis parallel to the rotation axis 22 of the photoconductor 21 and that accommodates the developer containing the toner in its inside space.

The transfer unit 26 is a transfer means for transferring the toner image, which is a visible image formed on the outside peripheral surface of the photoconductor 21 by development, onto the transfer paper 30, which is a recording medium supplied between the photoconductor 21 and the transfer unit 26 from a direction of an arrow 29 by a conveying means, not shown. For example, the transfer unit 26 is a non-contact type transfer means that includes a charge means and transfers a toner image onto the transfer paper 30 by giving the transfer paper 30 charges of a polarity reverse to that of the toner.

The cleaner 27 is a cleaning means for removing and collecting toner remaining on the peripheral surface of the photoconductor 21 after the operation of transfer by the transfer unit 26. The cleaner 27 includes a cleaning blade 27a for peeling off the toner remaining on the peripheral surface of the photoconductor 21 and a collection case 27b for containing the toner peeled off by the cleaning blade 27a. Furthermore, the cleaner 27 is disposed together with a discharge lamp, not shown.

The image forming apparatus 20 is also provided with the fixing unit 31, which is a fixing means for fixing the transferred image on the downstream side toward which the transfer paper 30 passing between the photoconductor 21 and the transfer unit 26 is conveyed. The fixing unit 31 is provided with a heat roller 31a having a heating means, not shown, and a pressure roller 31b disposed opposite the heat roller 31a so as to be pressed by the heat roller 31a to form an abutment.

Operation of image formation by the image forming apparatus 20 is carried out as follows. First, the photoconductor 21 is driven by the driving means to rotate in the direction of the arrow 23, and then the surface of the photoconductor 21 is uniformly charged to a predetermined positive or negative potential by the charger 24 provided at an upstream side of the rotation direction of the photoconductor 21 with respect to an image formation point of the light 28a applied by the exposure means 28.

Then, the surface of the photoconductor 21 is irradiated with the light 28a emitted from the exposure means 28 according to image information. In the photoconductor 21, surface charges of a part irradiated with the light 28a are eliminated by this exposure to make a difference between the surface potential of the part irradiated with the light 28a and the surface potential of the part not irradiated with the light 28a, thereby forming an electrostatic latent image.

Then, the toner is supplied to the surface of the photoconductor 21 on which the electrostatic latent image has been formed, from the developing unit 25 disposed on the downstream side with respect to the image formation point of the light 28a emitted from the exposure means 28 in the direction of the rotation of the photoconductor 21, to develop the electrostatic latent image, thereby forming a toner image.

In synchronization with the exposure for the photoconductor 21, the transfer paper 30 is fed between the photoconductor 21 and the transfer unit 26. Charges having a polarity opposite to that of the toner are provided to the fed transfer paper 30 by the transfer unit 26 to transfer the toner image formed on the surface of the photoconductor 21 onto the transfer paper 30.

Then, the transfer paper 30 on which the toner image has been transferred is conveyed to the fixing unit 31 by the conveying means, and heated and pressurized when it passes through the abutment between the heat roller 31a and the pressure roller 31b of the fixing unit 31 to fix the toner image to the transfer paper 30, thereby forming a fast image. The transfer paper 30 on which the image is thus formed is discharged out of the image forming apparatus 20 by the conveying means.

Meanwhile, the toner remaining on the surface of the photoconductor 21 even after the transfer of the toner image by the transfer unit 26 is peeled off the surface of the photoconductor 21 and collected by the cleaner 27. The charges on the surface of the photoconductor 21 from which the toner is removed in this manner are eliminated by light emitted from the discharge lamp so that the electrostatic latent image on the surface of the photoconductor 21 disappears. Thereafter, the photoconductor 21 is further driven to rotate, and the series of operations beginning with the charge is repeated again to form images continuously.

Some models of the image forming apparatus may be provided with no cleaning means such as the cleaner 27 for removing and collecting toner remaining on the photoconductor 21 and no discharge means for discharging surface charges remaining on the photoconductor 21.

Hereinafter, examples of the methods for preparing the coating solution for undercoat layer formation and the charge transfer material contained in the coating solution for charge transfer layer formation for the electrophotographic photoconductor of the present invention, and examples of the electrophotographic photoconductor and the image forming apparatus of the present invention will be described in detail based on the drawings. However, the present invention is not limited to the following examples.

### Production Example 1

### Production of Titanium Oxide Microparticles Coated with Anhydrous Silicon Dioxide 1

In a 50-liter reactor, 18.25 L of deionized water, 22.8 L of ethanol (product by Junsei Chemical Co., Ltd.) and 124 mL of 25 mass % aqueous ammonia (product by Taisei Kako Co., Ltd.) were mixed, and then 1.74 kg of titanium oxide particles (high purity titanium oxide F-10, product by Showa Titanium Co., Ltd., primary particle diameter: 150 nm) as a raw material was dispersed in the mixture to prepare a suspension A.

Next, 1.62 L of tetraethoxysilane (product by GE Toshiba Silicones Co., Ltd.) and 1.26 L of ethanol were mixed to prepare a solution B.

The solution B was added to the suspension A under stirring at a constant rate over 9 hours, and then aged at 45° C. for 12 hours to form a film at the same temperature.

Thereafter, the solid content was separated by centrifugal filtration and vacuum-dried at 50° C. for 12 hours, and further dried with warm air at 80° C. for 12 hours.

Subsequently, cracking was carried out by a jet mill to obtain titanium oxide microparticles coated with anhydrous silicon dioxide 1.

The obtained titanium oxide microparticles coated with anhydrous silicon dioxide 1 were measured for the particle diameter with an SEM photograph to find that the particle diameter was 160 nm to 170 nm.

### Production Example 2

### Production of Titanium Oxide Microparticles Coated with Anhydrous Silicon Dioxide 2

Titanium oxide microparticles coated with anhydrous silicon dioxide 2 were obtained in the same manner as in Production Example 1 except that the titanium oxide particles (high purity titanium oxide F-10, product by Showa Titanium Co., Ltd., primary particle diameter: 150 nm) as the raw material in Production Example 1 were changed to titanium oxide particles (high purity titanium oxide F-6, product by Showa Titanium Co., Ltd., primary particle diameter: 15 nm).

The obtained titanium oxide microparticles coated with anhydrous silicon dioxide 2 were measured for the particle diameter with an SEM photograph to find that the particle diameter was 16 nm to 17 nm.

### Production Example 3

### Production of Enamine Compound Represented by Formula (2)

### Production Example 3-1

### Production of Enamine Intermediate

To 100 ml of toluene, 23.3 g (1.0 equivalent) of N-(p-tolyl)-α-naphthylamine represented by the following formula (5):

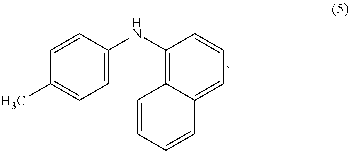

20.6 g (1.05 equivalents) of diphenylacetaldehyde represented by the following formula (6):

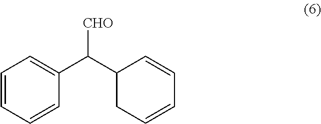

and 0.23 g (0.01 equivalents) of DL-10-camphorsulfonic acid were added, heated and reacted for 6 hours while removing by-product water out of the system by azeotropic separation with toluene. After completion of the reaction, the reaction solution was concentrated under reduced pressure until the volume thereof was reduced to approximately 1/10, and the concentrate obtained was gradually added dropwise to 100 mL of hexane under vigorous stirring to form a crystal. The crystal formed was filtered and washed with cold ethanol to obtain 36.2 g of a pale yellow powdered compound.

The compound obtained was analyzed by liquid chromatography-mass spectrometry (LC-MS) to observe a peak corresponding to a protonated molecular ion [M+H]+ of an enamine intermediate (calculated molecular weight: 411.20) represented by the following formula (7):

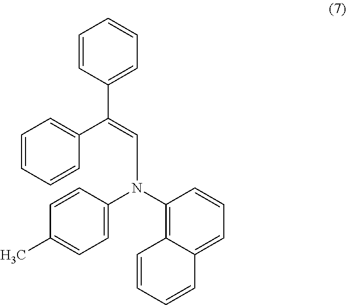

at 412.5 and therefore find that the obtained compound was an enamine compound intermediate represented by the formula (7) (yield: 88%).

In addition, the analysis of the LC-MS revealed that the purity of the enamine intermediate obtained was 99.5%.

Thus, the enamine intermediate represented by the formula (7) was obtained through dehydration condensation reaction of the N-(p-tolyl)-α-naphthylamine represented by the formula (5), which is a secondary amine compound, with the diphenylacetaldehyde represented by the formula (6), which is an aldehyde compound.

### Production Example 3-2

### Production of Enamine-Aldehyde Intermediate

To 100 ml of anhydrous N,N-dimethylformamide (DMF), 9.2 g (1.2 equivalents) of phosphorus oxychloride was gradually added under ice cooling and stirred for approximately 30 minutes to prepare a Vilsmeier reagent. Into this solution, 20.6 g (1.0 equivalent) of the enamine intermediate represented by the formula (7) obtained in Production Example 3-1 was gradually added under ice cooling. Thereafter, the reaction temperature was gradually raised up to 80° C., and stirring was carried out for 3 hours under heating to maintain the temperature at 80° C. After completion of the reaction, the reaction solution was allowed to cool and gradually added to 800 ml of cooled 4N aqueous sodium hydroxide to form a precipitate. The precipitate formed was filtered, sufficiently washed with water, and then recrystallized with a mixed solvent of ethanol and with ethyl acetate to obtain 20.4 g of a yellow powdered compound.

The compound obtained was analyzed by LC-MS to observe a peak corresponding to a protonated molecular ion [M+H]+ of an enamine-aldehyde intermediate (calculated molecular weight: 439.19) represented by the following formula (8):

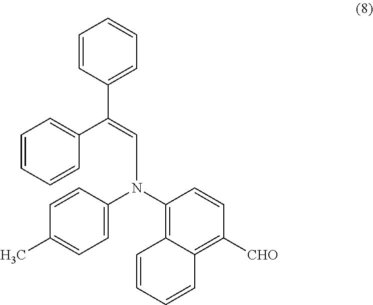

at 440.5 and therefore find that the obtained compound was an enamine-aldehyde intermediate represented by the formula (8) (yield: 93%). In addition, the analysis of the LC-MS revealed that the purity of the enamine-aldehyde intermediate obtained was 99.7%.

Thus, the enamine-aldehyde intermediate represented by the formula (8) was obtained by formylating the enamine intermediate represented by the formula (7) through a Vilsmeier reaction.

### Production Example 3-3

### Production of Enamine Compound Represented by Formula (2)

In 80 ml of anhydrous DMF, 8.8 g (1.0 equivalent) of the enamine-aldehyde intermediate represented by the formula (8) obtained in Production Example 3-2 and 6.1 g (1.2 equivalents) of diethyl cinnamyl phosphate represented by the following formula (9):

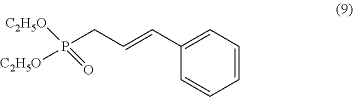

were dissolved, and then 2.8 g (1.25 equivalents) of potassium t-butoxide was gradually added to the solution at room temperature, heated up to 50° C. and stirred for 5 hours under heating to maintain the temperature at 50° C.

The reaction mixture was allowed to cool, and then poured into excessive methanol. A deposit was collected and dissolved in toluene to obtain a toluene solution. The toluene solution was moved to a separatory funnel to be washed with water, and then an organic layer was taken out to be dried with magnesium sulfate. After the drying, solid matters were removed from the organic layer, and then the organic layer was concentrated and subjected to silica gel column chromatography to obtain 10.1 g of a yellow crystal.

The crystal obtained was analyzed by LC-MS to observe a peak corresponding to a protonated molecular ion [M+H]+ of the desired enamine compound (calculated molecular weight: 539.26) represented by the formula (2) at 540.5.

In addition, the crystal obtained was measured for the nuclear magnetic resonance (abbreviated as NMR) spectrum in deuterated chloroform (chemical formula: CDCl₃), and the crystal was identified to be the enamine compound represented by the formula (2) from the spectrum.

The analysis of the LC-MS and the measurement for the NMR spectrum revealed that the crystal obtained was the enamine compound represented by the formula (2) (yield: 94%). In addition, the analysis of the LC-MS revealed that the purity of the obtained enamine compound represented by the formula (2) was 99.8%.

Thus, the enamine compound represented by the formula (2) was obtained by carrying out Wittig-Horner reaction between the enamine-aldehyde intermediate represented by the formula (8) and the diethyl cinnamyl phosphate represented by the formula (9) as a Wittig reagent.

### Example 1

Silicon nitride beads as a dispersion medium having a diameter of 0.5 mm were put into a horizontal bead mil having a volume of 16500 mL in an amount up to 80% of the volume of the bead mill, and then the following components:

| | | |
|---|---|---|
| Maxlight (registered trademark) TS-043 (product by | 1 | part by weight |
| Showa Denko K.K., titanium oxide treated with an- | | |
| hydrous silicon dioxide, titanium oxide: 90% by | | |
| weight, anhydrous silicon dioxide: 10% by weight, | | |
| particle diameter of titanium oxide: 30 nm, particle | | |
| diameter of titanium oxide treated with anhydrous | | |
| silicon dioxide: 32 nm) | | |
| polyamide resin (CM8000, product by Toray | 9 | parts by weight |
| Industries, Inc.) | | |
| ethanol | 50 | parts by weight |
| tetrahydrofuran | 50 | parts by weight |

were stored in a stirring tank and sent to the disperser through a diaphragm pump to be dispersed under circulation for 15 hours to prepare 3000 g of a coating solution for undercoat layer formation.

An undercoat layer having a film thickness of 0.15 μm was formed on a cylindrical aluminum support having a diameter of 30 mm and a total length of 345 mm as a conductive support by a dipping coating method using a coating vessel filled with the coating solution for undercoat layer formation.

Then, a mixture of the following components:

| | |
|---|---|
| τ type metal-free phthalocyanine, Liophoton | 2 parts by weight |
| TPA-891 (product by Toyo Ink Mfg. Co., Ltd.) | |
| polyvinyl butyral resin (S-LEC BM-S, | 2 parts by weight |
| product by SEKISUI CHEMICAL CO., LTD.) | |
| methyl ethyl ketone | 100 parts by weight |

was dispersed in a ball mill for 12 hours to prepare 2000 g of a coating solution for charge generation layer formation. Then, this coating solution was applied onto the undercoat layer by the same method as in the case of the undercoat layer and dried with hot air at 120° C. for 10 minutes to form the charge generation layer 5 having a dried film thickness of 0.8 μm.

Subsequently, the following components:

| | | |
|---|---|---|
| enamine compound represented by the | 10 | parts by weight |
| formula (2) | | |
| polycarbonate resin (Z200, product by | 20 | parts by weight |
| Mitsubishi Engineering-Plastics Corporation) | | |
| silicone oil KF50 (product name, product by | 0.02 | parts by weight |
| Shin-Etsu Chemical Co., Ltd.) | | |
| tetrahydrofuran | 120 | parts by weight |

were mixed and dissolved to prepare 3000 g of a coating solution for charge transfer layer formation, and then this coating solution was applied onto the charge generation layer by the same method as in the case of the undercoat layer and dried at 110° C. for 1 hour to form a charge transfer layer having a film thickness of 25 μm. Thus, a sample function separation type electrophotographic photoconductor was produced.

### Example 2

An undercoat layer was prepared in the same manner as in Example 1 except that the components of the coating solution for undercoat layer formation used in Example 1 were changed to the following components:

| | | |
|---|---|---|
| titanium oxide (treated with Al₂O₃ and | 4 | parts by weight |
| SiO₂•nH₂O, MT-500SA, product by Tayca, | | |
| titanium oxide: 90% by weight, Al(OH)₃: | | |
| 5% by weight, SiO₂•nH₂O: 5% by weight | | |
| Maxlight (registered trademark) TS-043 | 5.5 | parts by weight |
| (product by Showa Denko K.K.) | | |
| polyamide resin (CM8000, product by Toray | 0.5 | parts by weight |
| Industries, Inc.) | | |
| methanol | 120 | parts by weight |
| 1,3-dioxolane | 120 | parts by weight |

and then a function separation type electrophotographic photoconductor was produced in the same manner as in Example 1.

### Example 3

An undercoat layer was prepared in the same manner as in Example 1 except that Maxlight (registered trademark) ZS-032 (product by Showa Denko K.K., zinc oxide treated with anhydrous silicon dioxide, zinc oxide: 80% by weight, anhydrous silicon dioxide: 20% by weight, particle diameter of zinc oxide: 25 nm, particle diameter of zinc oxide treated with anhydrous silicon dioxide: 31 nm) was used instead of the Maxlight (registered trademark) TS-043 (product by Showa Denko K.K.) as the component of the coating solution for undercoat layer formation used in Example 1, and then a function separation type electrophotographic photoconductor was produced in the same manner as in Example 1.

### Example 4

A function separation type electrophotographic photoconductor was produced in the same manner as in Example 1 except that the Maxlight (registered trademark) TS-043 (product by Showa Denko K.K.) as the component of the coating solution for undercoat layer formation used in Example 1 was changed to the titanium oxide microparticles coated with anhydrous silicon dioxide 1 obtained in Production Example 1.

### Example 5

A function separation type electrophotographic photoconductor was produced in the same manner as in Example 1 except that the Maxlight (registered trademark) TS-043 (product by Showa Denko K.K.) as the component of the coating solution for undercoat layer formation used in Example 1 was changed to the titanium oxide microparticles coated with anhydrous silicon dioxide 2 obtained in Production Example 2.

### Example 6

A function separation type electrophotographic photoconductor was produced in the same manner as in Example 1 except that the components of the coating solution for undercoat layer formation used in Example 1 were changed as follows:

| | | |
|---|---|---|
| Maxlight (registered trademark) TS-043 | 2 | parts by weight |
| (product by Showa Denko K.K.) | | |
| polyamide resin (CM8000, product by Toray | 0.05 | parts by weight |
| Industries, Inc.) | | |
| methanol | 50 | parts by weight |
| 1,3-dioxolane | 50 | parts by weight |

### Example 7

A function separation type electrophotographic photoconductor was produced in the same manner as in Example 1 except that the dried film thickness of the undercoat layer prepared in Example 1 was changed to 0.04 μm.

### Example 8

A function separation type electrophotographic photoconductor was produced in the same manner as in Example 1 except that the dried film thickness of the undercoat layer prepared in Example 1 was changed to 6.00 μm.

### Example 9

A charge transfer layer was prepared in the same manner as in Example 1 except that 10 parts by weight of the enamine compound represented by the formula (3) was used instead of 10 parts by weight of the enamine compound represented by the formula (2) as the component of the coating solution for charge transfer layer formation used in Example 1, and then a function separation type electrophotographic photoconductor was produced in the same manner as in Example 1.

### Example 10

A charge transfer layer was prepared in the same manner as in Example 1 except that 10 parts by weight of the enamine compound represented by the formula (4) was used instead of 10 parts by weight of the enamine compound represented by the formula (2) as the component of the coating solution for charge transfer layer formation used in Example 1, and then a function separation type electrophotographic photoconductor was produced in the same manner as in Example 1.

### Example 11

A function separation type electrophotographic photoconductor was produced in the same manner as in Example 1 except that the components of the coating solution for charge transfer layer formation used in Example 1 were changed to the following components:

| | | |
|---|---|---|
| enamine compound represented by | 5 | parts by weight |
| the formula (2) | | |
| polycarbonate resin (Z200, product by | 16 | parts by weight |
| Mitsubishi Engineering-Plastics Corporation) | | |
| silicone oil KF50 (product by Shin-Etsu | 0.02 | parts by weight |
| Chemical Co., Ltd.) | | |
| tetrahydrofuran | 110 | parts by weight |

### Example 12

A function separation type electrophotographic photoconductor was produced in the same manner as in Example 1 except that the components of the coating solution for charge transfer layer formation used in Example 1 were changed to the following components:

| | | |
|---|---|---|
| enamine compound represented | 15 | parts by weight |
| by the formula (2) | | |
| polycarbonate resin (Z200, product by | 15 | parts by weight |
| Mitsubishi Engineering-Plastics Corporation) | | |
| silicone oil KF50 (product by | 0.02 | parts by weight |
| Shin-Etsu Chemical Co., Ltd.) | | |
| tetrahydrofuran | 100 | parts by weight |

### Comparative Example 1

A function separation type electrophotographic photoconductor was produced in the same manner as in Example 1 except that the components of the coating solution for undercoat layer formation used in Example 1 were changed to the following components:

| | | |
|---|---|---|
| zinc oxide (treated with alumina•organic | 0.1 | parts by weight |
| polysiloxane, FINEX-30WL2, product by Sakai | | |
| Chemical Industry Co., Ltd.) | | |
| polyamide resin (CM8000, product by Toray | 0.9 | parts by weight |
| Industries, Inc.) | | |
| methanol | 50 | parts by weight |
| 1,3-dioxolane | 50 | parts by weight |

### Comparative Example 2

A function separation type electrophotographic photoconductor was produced in the same manner as in Example 1 except that 1 part by weight of the Maxlight (registered trademark) TS-043 (product by Showa Denko K.K.) as the component of the coating solution for undercoat layer formation used in Example 1 was changed to 1 part by weight of another titanium oxide (surface untreated, TTO-55N, product by Ishihara Sangyo Kaisha, Ltd.)

### Comparative Example 3

A function separation type electrophotographic photoconductor was produced in the same manner as in Example 1 except that 1 part by weight of the Maxlight (registered trademark) TS-043 (product by Showa Denko K.K.) as the component of the coating solution for undercoat layer formation used in Example 1 was changed to 1 part by weight silicon dioxide (surface untreated, UFP-80, product by Denki Kagaku Kogyo K. K.)

### Comparative Example 4

A function separation type electrophotographic photoconductor was produced in the same manner as in Example 1 except that 1 part by weight of the Maxlight (registered trademark) TS-043 (product by Showa Denko K.K.) as the component of the coating solution for undercoat layer formation used in Example 1 was changed to 2 parts by weight of titanium oxide treated with alumina (TTO-55A, product by Ishihara Sangyo Kaisha, Ltd., titanium oxide: 95% by weight, Al(OH)₃: 5% by weight).

### Comparative Example 5

A function separation type electrophotographic photoconductor was produced in the same manner as in Example 1 except that the components of the coating solution for charge transfer layer formation used in Example 1 were changed to the following components:

| | |
|---|---|
| hydrazone compound represented by the following formula (10) | 8 parts by weight |
| polycarbonate resin K1300 (product by TEIJIN CHEMICALS LTD.) | 10 parts by weight |
| silicone oil KF50 (product by Shin-Etsu Chemical Co., Ltd.) | 0.02 parts by weight |
| tetrahydrofuran | 120 parts by weight |

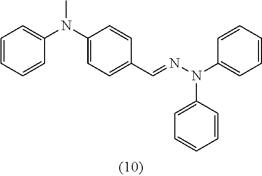

### Comparative Example 6

A function separation type electrophotographic photoconductor was produced in the same manner as in Example 1 except that the components of the coating solution for charge transfer layer formation used in Example 1 were changed to the following components:

| | |
|---|---|
| butadiene compound represented by the following formula (11) | 9 parts by weight |
| polycarbonate resin K1300 (product by TEIJIN CHEMICALS LTD.) | 12 parts by weight |
| silicone oil KF50 (product by Shin-Etsu Chemical Co., Ltd.) | 0.02 parts by weight |
| tetrahydrofuran | 120 parts by weight |

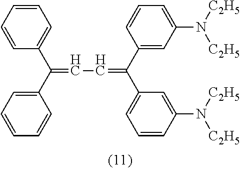

The following evaluations (a) to (c) were carried out using the function separation type electrophotographic photoconductors produced in Examples 1 to 12 and Comparative Examples 1 to 6 as described above.

### (a) Evaluation of Environmental Stability in Electric Characteristics

The electrophotographic photoconductors of Examples 1 to 12 and Comparative Examples 1 to 6 were mounted in a digital copying machine (AR-450M, product by Sharp Corporation) that had been modified so that the exposure and the exposure-development time can be optionally changed for photoconductor tests, and evaluated for the environmental stability in initial electric characteristics.

Specifically, the photoconductors were measured for the surface potential when exposed at exposures of 0.2 μJ/cm² and 0.6 μJ/cm² under a low-temperature/low-humidity environment (L/L, 5° C./10%) and a high-temperature/high-humidity environment (H/H, 35° C./85%) (initial charged voltage: −600 V, exposure-development time: 84 msec), and evaluated based on the difference ΔV_{LL-HH} between the surface potential under the low-temperature/low-humidity environment and the surface potential under the high-temperature/high-humidity environment. That is, the smaller value of ΔV_{LL-HH} indicates more excellent environmental stability in electric characteristics.

### (b) Evaluation of Responsiveness

The electrophotographic photoconductors of Examples 1 to 12 and Comparative Examples 1 to 6 were mounted in the modified digital copying machine AR-450M and exposed at an exposure twice the half decay exposure under the low-temperature/low-humidity environment (L/L, 5° C./10%) to be evaluated for the responsiveness based on variation ΔVb of the potential (Vb) according to the exposure-development time (84 ms to 40 ms). That is, the smaller ΔVb indicates less susceptibility to the exposure-development time and more excellent responsiveness.

### (c) Evaluation of Durability

The electrophotographic photoconductors of Examples 1 to 12 and Comparative Examples 1 to 6 were mounted in a digital copying machine (AR-451, product by Sharp Corporation) and evaluated for the sensitivity, the image properties and the printing durability after completion of aging by 100000 sheets of copying to be determined for the durability in each property. The evaluation for the sensitivity was based on the potential when black solid printing was carried out in a copier mode, and the evaluation for the printing durability was based on the film wear amount when each electrophotographic photoconductor completed 100000 cycles.

The image properties were evaluated according to the following criteria.

### Criteria:

G (GOOD): No defect of black dots observed.

NG (NOT GOOD): Defect of black dots observed, but no problem in practical use.

B (BAD): Significant defect of black dots observed, and problem in practical use.

VB (VERY BAD): Image fogging observed.

The following table shows the results of the evaluations carried out according to (a) to (c) described above.

TABLE 1

| | | | | Evaluation of durability | | | | |
|---|---|---|---|---|---|---|---|---|
| | Environmental stability | | | | | | | Printing durability |
| | ΔV_{LL-HH} | | Responsiveness | Electric characteristics | | Image | | Film wear |
| Examples | 0.2 μJ/cm² | 0.6 μJ/cm² | ΔVb | Initial | 100K | Initial | 100K | ( [symbol] m/100K cycles) |
| Example 1 | 40 | 32 | 40 | −70 | −82 | G | G | 1.17 |
| Example 2 | 33 | 27 | 41 | −76 | −91 | G | G | 1.09 |
| Example 3 | 72 | 61 | 66 | −77 | −90 | G | G | 1.21 |
| Example 4 | 66 | 43 | 63 | −82 | −94 | G | G | 1.21 |
| Example 5 | 82 | 51 | 65 | −87 | −100 | G | G | 1.18 |
| Example 6 | 76 | 41 | 41 | −72 | −91 | G | G | 1.26 |
| Example 7 | 52 | 43 | 44 | −111 | −125 | G | NG | 1.20 |
| Example 8 | 29 | 24 | 70 | −73 | −83 | G | G | 1.16 |
| Example 9 | 57 | 46 | 52 | −75 | −85 | G | G | 1.16 |
| Example 10 | 61 | 55 | 88 | −102 | −120 | G | NG | 1.17 |
| Example 11 | 54 | 38 | 70 | −66 | −79 | G | G | 1.11 |
| Example 12 | 45 | 39 | 43 | −77 | −88 | G | G | 1.23 |
| Comp. Ex. 1 | 143 | 133 | 92 | −146 | −205 | B | VB | 1.22 |
| Comp. Ex. 2 | 122 | 117 | 64 | −134 | −188 | G | VB | 1.25 |
| Comp. Ex. 3 | 134 | 123 | 87 | −154 | −191 | B | VB | 1.19 |
| Comp. Ex. 4 | 145 | 133 | 125 | −152 | −198 | G | B | 1.31 |
| Comp. Ex. 5 | 88 | 90 | 122 | −96 | −134 | B | B | 2.09 |
| Comp. Ex. 6 | 77 | 76 | 113 | −106 | −156 | B | B | 1.89 |

Comparison between the results of Examples 1 to 12 and the results of Comparative Examples 1 to 4 in terms of the evaluation of the environmental stability and the sensitivity has revealed that the surface treatment process with the anhydrous silicon dioxide for the metal microparticles to be contained in the undercoat layer in the present invention is effective.

Comparison between the results of Examples 1 to 12 and the results of Comparative Examples 5 and 6 has revealed that the surface treatment process with the anhydrous silicon dioxide for the metal microparticles to be contained in the coating solution for undercoat layer formation and use of an enamine compound as the charge transfer material to be contained in the coating solution for charge transfer layer formation in the present invention are the most effective in order to achieve the environmental stability, higher sensitivity and higher responsiveness.

Further, in terms of the evaluation of the durability, it has been revealed that the electrophotographic photoconductors of the present invention can produce good results in the sensitivity, the images and the film wear in the initial stage and after aging, that is, they are excellent in the durability, showing insusceptibility to humidity, higher sensitivity and higher responsiveness even in long-term use to provide an image forming apparatus that can output excellent images over a long term.

Comparison between the results of Examples 1 to 3 and the results of Comparative Examples 1 to 3 has revealed that the performance is more improved in terms of the environmental stability, the responsiveness and the sensitivity by using titanium oxide or zinc oxide microparticles out of various metal microparticles.

Comparison between the result of Example 1 and the results of Examples 4 and 5 has revealed that it is more preferable that the primary particle diameter of the titanium oxide microparticles is 20 nm to 100 nm in terms of the environmental stability.

Comparison between the result of Example 1 and the results of Examples 7 and 8 has revealed that it is more preferable that the film thickness of the undercoat layer is 0.05 μm to 5 μm in terms of the environmental stability, the sensitivity and the responsiveness.

Comparison between the results of Examples 1 to 12 and the results of Comparative Examples 1 to 6 has revealed that all of the photoconductors of the present invention in which the enamine compounds represented by the formulae (2) to (4) produced good results in the evaluations described above and therefore can be suitably used in image forming apparatuses with no difficulty in terms of the responsiveness and the sensitivity.

Comparison between the result of Example 1 and the results of Examples 11 and 12 has revealed that it is preferable that the enamine compound is contained in the charge transfer layer at a ratio by weight of 10/10 to 10/30 with respect to the binder resin in terms of the responsiveness and the durability.

The present invention can provide an electrophotographic photoconductor having very stable environmental properties, preventing deterioration in the image properties even in long-term and repeated use.

What is claimed is:

1. A function separation type electrophotographic photoconductor comprising:
a conductive support;
an undercoat layer formed on the conductive support;
a charge generation layer formed on the undercoat layer; and
a charge transfer layer formed on the charge generation layer,
the undercoat layer containing at least a binder resin and metal oxide particles subjected to surface treatment with anhydrous silicon dioxide,
the charge transfer layer containing at least a binder resin and an enamine compound represented by the following general formula (1): 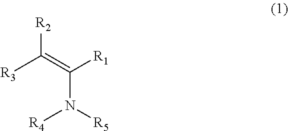
wherein one or more of R₁, R₂, R₃, R₄ and R₅ represent a C₆-C₁₀ aryl group that may have a substituent; the others each represent hydrogen atom or C₁-C₄ alkyl, C₄-C₉ heterocyclic, C₇-C₁₆ aralkyl or C₁₁-C₁₆ arylidene alkyl group that may have a substituent; or R₂ and R₃ together with carbon atoms with which they are combined may form a cyclic or condensed cyclic group that may have a substituent.

2. The photoconductor according to claim 1, wherein the enamine compound represented by the formula (1) is an enamine compound in which one or more of R₁, R₂, R₃, R₄ and R₅ is phenyl, p-tolyl, p-methoxyphenyl, 4-(4-phenyl butadienyl)-naphthyl or 4-(4-phenyl-4-p-methoxyphenyl butadienyl)-naphthyl group, and the others are hydrogen atom, or 1,2,3,4-tetrahydro naphthylidene methyl, 1-(1,2,3,4-tetrahydro)-naphthylidene or 1-(1,2,3,4-tetrahydro)-naphthylidene methyl group.

3. The photoconductor according to claim 1, wherein the enamine compound represented by the formula (1) is
an enamine compound containing hydrogen atom as R₁, phenyl groups as R₂ and R₃, p-tolyl group as R₄ and 4-(4-phenylbutadienyl)-naphthyl group as R₅, and represented by the formula (2): 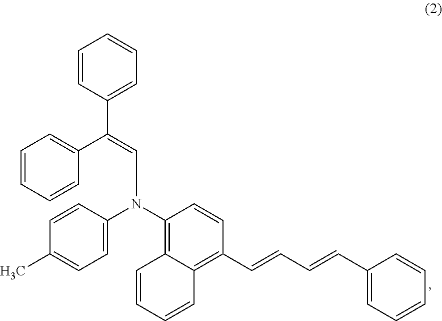
an enamine compound containing hydrogen atom as R₁, phenyl groups as R₂ and R₃, p-tolyl group as R₄ and 4-(4-phenyl-4-p-methoxyphenyl butadienyl)-naphthyl group as R₅, and represented by the formula (3): 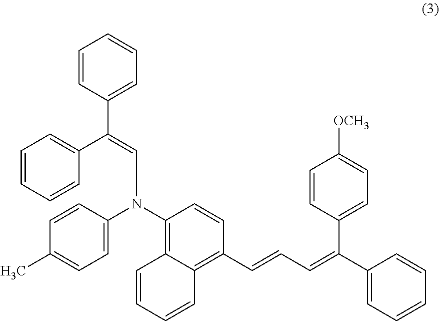
or
an enamine compound containing hydrogen atom as R₁, 1-(1,2,3,4-tetrahydro)-naphthylidene groups as R₂ and R₃, which are formed by R₂ and R₃ together with carbon atoms with which they are combined, p-methoxyphenyl group as R₄ and 1-(1,2,3,4-tetrahydro)-naphthylidene methyl group as R₅, and represented by the formula (4):

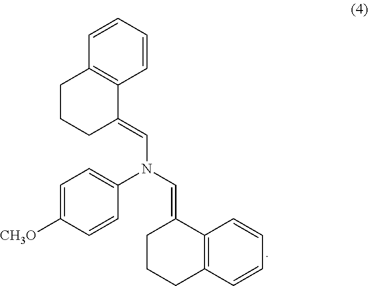

4. The photoconductor according to claim 1, wherein the enamine compound is used in a ratio by weight of 10/10 to 10/30 with respect to the binder resin.

5. The photoconductor according to claim 1, wherein the metal oxide particles have an average primary particle diameter of 20 nm to 100 nm.

6. The photoconductor according to claim 1, wherein the metal oxide particles are used in a ratio by weight of 10/90 to 95/5 with respect to the binder resin.

7. The photoconductor according to claim 1, wherein the metal oxide particles are titanium oxide or zinc oxide particles.

8. The photoconductor according to claim 1, wherein the binder resin contained in the undercoat layer is a polyamide resin.

9. The photoconductor according to claim 1, wherein the undercoat layer has a film thickness of 0.05 μm to 5 μm.

10. An image forming apparatus comprising the electrophotographic photoconductor according to 1 to 9.
